(19) United States
(12) Patent Application Publication
(10) Pub. No.: US 2004/0250292 A1
(43) Pub. Date: Dec. 9, 2004

(54) Digital/analog broadcast receiver

(76) Inventors: Kenji Okamoto, Daito-shi (JP); Toshihiro Takagi, Daito-shi (JP); Yasuhiro Inui, Daito-shi (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/863,326

(22) Filed: Jun. 9, 2004

(30) Foreign Application Priority Data
Jun. 9, 2003 (JP) 2003-163208

(51) Int. Cl. H04N 7/173; G06F 13/00; H04N 5/445; H04N 7/16; G06F 3/00

(52) U.S. Cl. 725/131; 348/734; 348/731; 348/384.1; 725/139; 725/37

(57) ABSTRACT

There is provided a digital/analog broadcast receiver in which the main processor creates a channel map indicating whether each channel is being broadcast on the basis of the EIT and VCT contained in an ATSC broadcast, analyzes the anticipated increase or decrease in channels on the basis of the EIT and VCT as the ATSC broadcast signal is being received, and stores the scheduled channel increase/decrease information as the analysis result in memory. The main processor updates the channel map at the scheduled channel increase/decrease time on the basis of the scheduled channel increase/decrease information. When the channel up/down key is operated by the user, the main processor automatically selects the next channel in the up or down direction from among the channels registered in the channel map at that point in accordance with the operation of the channel up/down key. The convenience of the user can thereby be improved.

### BACKGROUND OF THE INVENTION

1. Field of the Invention

The present invention relates to a digital/analog broadcast receiver.

2. Description of the Related Art

With the development of digital technology, digital television broadcasting is being distributed and has rapidly become widespread in recent years. In digital television broadcasting, a plurality of television programs is distributed from a broadcast station in a single frequency band. This is carried out by compression-encoding the audio and video of a plurality of television programs with digital compression technology, thereafter time-division multiplexing the signal, modulating the signal into a high frequency radio wave with a predetermined frequency band, and distributing the signal as a television broadcast signal. Also, in digital television broadcasting, broadcast programs, broadcast channels thereof, and other types of electronic program information are time-division multiplexed and distributed together with the audio and video of television programs in predetermined time segments. In digital television broadcasting, the television broadcast signal of a predetermined frequency band in which the broadcast signal of a plurality of television programs is multiplexed is called the “physical channel,” and the broadcast signal of each television program multiplexed in the frequency band thereof is called the “subchannel.”

When the user selects with the remote control or the like the channel (in other words, physical channel and subchannel) with the program he wishes to view in a broadcast receiver for receiving a digital television broadcast, a high frequency radio wave in the frequency band corresponding to the physical channel thereof is received by the broadcast receiver and the received signal is demodulated, whereby a signal can be obtained in which the audio and video of a plurality of compression-encoded television programs, as well as electronic program information and other signals, are time-division multiplexed. This signal is referred to as a “transport stream signal.”

The above-described broadcast receiver then separates and extracts from the transport stream signal the audio and video signals of the television broadcast corresponding to the subchannel, demodulates the audio and video signals to the state preceding compression encoding, and outputs the result to the television monitor. Also, the broadcast receiver extracts electronic program information from the transport stream signal.

In North America, broadcasts that conform to the standards developed by ATSC (Advanced Television Systems Committee), which is one type of the digital television broadcast described above, are distributed. ATSC broadcasting is a multiplexing method in which information that contains various data related to a television broadcast and called PSIP (Program and System Information Protocol) is distributed together with the audio and video of a plurality of television programs in each physical channel. PSIP furthermore contains electronic program information called VCT (Virtual Channel Table) and EIT (Event Information Table).

The VCT, as pertains to a television program currently being broadcast, contains information about the channel number that is broadcasting the television program, and the Source ID that is in a one-to-one relationship with the subchannel, and is information showing the correspondence relationship between the Source ID and the channel number in each television program currently being broadcast. The EIT, as pertains to television programs currently being broadcast and scheduled to be broadcast, contains the Source ID as well as the program name, program start and end times, and other program information; and is information showing the correspondence relationship between the Source ID and the program information in each television program currently being broadcast and scheduled to be broadcast.

As described above, the EIT contains the Source ID as well as the program name, program start and end times, and other program information, but information about the channel on which the television program is broadcast is not included. The VCT, on the other hand, contains the information about the channel on which the television program is being broadcast and the Source ID thereof, but does not include the program name, program start and end times, and other program information. For this reason, the association between the program name and broadcast time of a television program and the broadcast channel thereof is carried out based on the Source ID contained in both the EIT and VCT.

Among conventional analog broadcast receivers, there are broadcast receivers in which the desired channel can be selected one at a time by using a channel up/down key during channel selection, and in digital broadcast receivers as well, it is possible to use the channel up/down key in the same manner to select a channel. However, there is a drawback in digital broadcasting in that the number of channels is greater in comparison with analog broadcasting, and among these channels there are many channels that are not broadcast, so in a method whereby the channel is changed up and down one at a time by using the channel up/down key, many channels which are not being broadcast end up being selected, and the user cannot quickly select the desired channel.

On the other hand, Japanese Laid-open Patent Publication No. 2001-177778 discloses a receiver and a receiving method wherein electronic program information for all physical channels being broadcast is retrieved from a transport stream signal and stored in memory, the channels in progress that match predetermined conditions are searched on the basis of information written to memory in accordance with the operation of the channel up/down key, and the program on the channel that matches the conditions is selected and displayed.

However, Japanese Laid-open Patent Publication No. 2001-177778 does not disclose the selection method based on the use of a channel up/down key in the case of a receiver for receiving broadcast signals in which the transport stream signal in the broadcast signal contains solely electronic program information related to the physical channel being received, as in a receiver for an ATSC broadcast signal.

### SUMMARY OF THE INVENTION

An object of the present invention is to provide a digital/analog broadcast receiver that is capable of improving user's convenience with a configuration in which channels that are not being broadcast are not selected during selection of digital broadcast channels with a channel up/down key.

The digital/analog broadcast receiver in accordance with one aspect of the present invention comprises receiving means for receiving an ATSC (Advanced Television Systems Committee) broadcast signal whereby video information about a plurality of television programs is distributed together with VCT (Virtual Channel Table) information showing the correspondence relationship between the channels that broadcast these television programs and the Source ID uniquely given to these channels, and EIT (Event Information Table) information showing the correspondence relationship between the Source ID and the program information for each television program; a decoder for reproducing the video signal of the television program, outputting the video signal to a television monitor connected to the device, and extracting the EIT information and VCT information, from the ATSC broadcast signal received by the receiving means; channel map creating means for creating a channel map wherein information as to whether each of the channels is being broadcast is stored, based on the extracted VCT information and EIT information; operating means having a channel up/down key for allowing the user to select a desired channel; channel selection control means for controlling the channel selecting processing on the basis of the channel up/down key operation by the user; analysis means for analyzing the scheduled channel increase/decrease on the basis of the VCT information and EIT information while the ATSC broadcast signal is being received by the receiving means; scheduled channel increase/decrease storage means for storing the scheduled channel increase/decrease information, which is the analysis result by the analysis means; and channel map update means for updating the channel map at the scheduled channel increase/decrease time on the basis of the scheduled channel increase/decrease information stored in the scheduled channel increase/decrease storage means.

The channel selection control means automatically selects the next channel in the up or down direction from among the channels registered at that point in the channel map in accordance with the operation of the channel up/down key when it has been detected that the user has operated the channel up/down key.

In the above-described configuration, when the user has operated the channel up/down key, the next channel is automatically selected in the up or down direction from among the channels registered in the channel map at that point. When selecting an ATSC broadcast channel, which is one type of digital broadcast, it is thereby ensured that channels that are not being broadcast are not selected, and user's convenience can be improved. Also, channel selection with the channel selection control means is performed based on the information of whether each channel stored in the channel map is currently being broadcast, so the retrieval of ECT and VCT information for each channel is not necessarily required when the channel up/down key has been operated. Therefore, when the user has selected a channel by using the channel up/down key, the channel can be rapidly changed.

The channel selection control means preferably judges whether or not the selected channel is actually being broadcast, and automatically selects the next channel when it is concluded that the channel is not actually being broadcast.

The channel selection control means more preferably judges whether or not the selected channel is actually being broadcast, and, when it is concluded that the channel is not actually being broadcast, outputs a signal indicating that fact to the television monitor, updates the channel map and the scheduled channel increase/decrease information stored in the scheduled channel increase/decrease storage means on the basis of the VCT and EIT information contained in the ATSC broadcast signal newly received from the receiving means, and automatically selects the next channel in the up or down direction from among the channels registered in the updated channel map.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram showing a general structure of the digital/analog broadcast receiver in accordance with a first embodiment of the present invention;

FIG. 2 is a diagram of the channel map of the above receiver;

FIG. 3 is a diagram of the updating method of the channel map of the above receiver;

FIG. 4 is a diagram of the EIT received by the above receiver;

FIG. 5 is a diagram of the VCT received by the above receiver;

FIG. 6 is a diagram showing an example of the correspondence relationship between the channel number and the Source ID in the above receiver;

FIG. 7 is a flowchart showing the channel selection processing with the channel up key in the above receiver; and

FIG. 8 is a flowchart showing the channel selection processing with the channel up key in the digital/analog broadcast receiver in accordance with a second embodiment of the present invention.

### DETAILED DESCRIPTION OF THE EMBODIMENTS

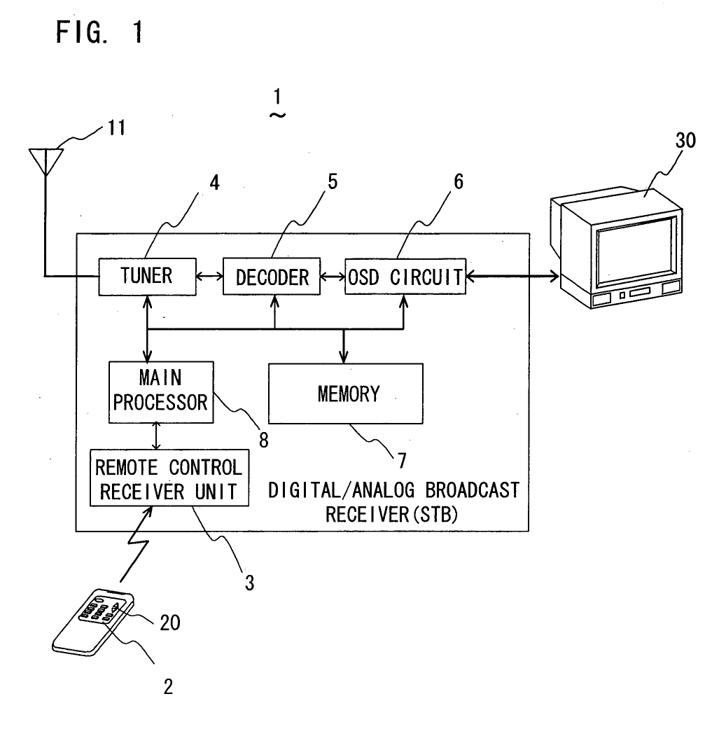

A first embodiment exemplifying the present invention is described below with reference to the diagrams. FIG. 1 shows an electrical block diagram of the general structure of the digital/analog broadcast receiver in accordance with the first embodiment of the present invention. An antenna 11 for receiving television broadcast signals transmitted on a high frequency radio wave at a predetermined frequency from a broadcasting station, and a television monitor 30 for outputting audio together with showing the video of the television broadcast are connected to a digital/analog broadcast receiver (STB: Set-Top Box) 1.

The broadcast receiver 1 is a device for receiving ATSC broadcast signals or other digital or analog broadcast signals distributed by the broadcast station by way of the antenna 11, and outputting the audio and video of these television broadcasts to a television monitor 30.

The broadcast receiver 1 comprises a remote control 2, a remote control receiver unit 3, a tuner (receiving means) 4, a decoder 5, an OSD circuit 6, memory (scheduled channel increase/decrease storage means) 7, and a main processor (channel selection means, channel map creation means, analysis means, and channel map update means in the claims) 8.

When the television program that the user will view is selected, the remote control 2 transmits an infrared signal or another wireless signal that corresponds to the user's operation of the channel up/down key (operating means) 20. The remote control receiver unit 3 receives the signal transmitted from the remote control 2, and outputs the signal to the main processor 8. The tuner 4 receives the television broadcast signal of the selected channel via the antenna 11 by causing the received frequency thereof to tune to the frequency corresponding to the channel (e.g. physical channel in the ATSC broadcast) selected by operation with the remote control 2.

When an ATSC broadcast channel is selected with the remote control 2, the decoder 5 demodulates the signal received by the tuner 4 and generates a transport stream signal in a state in which digitally compression-encoded signals such as the audio, video, and electronic program information in the plurality of television programs are time-division multiplexed. The decoder 5 then separates and extracts from the transport stream signal the audio and video signals of the television program of the subchannel selected with the remote control 2, and these signals are decoded and reproduced as the signals prior to digital compression encoding, and are output to the television monitor 30. Also, the decoder 5 extracts the VCT and EIT information, which are the electronic program information, from the transport stream signal, and outputs the information to the main processor 8.

When an analog broadcast channel is selected with the remote control 2, the decoder 5 demodulates the signal received by the tuner 4, reproduces the audio and video signals of the television program of the channel that was selected with the remote control 2, and outputs the audio and video signals to the television monitor 30.

When the channel selected based on the user's operation of the up/down key 20 is not being broadcast, the OSD circuit 6 superposes the video signal output from the decoder 5 with an OSD signal indicating that the channel is not being broadcast, and outputs the result to the television monitor 30.

The memory 7 stores the scheduled channel increase/decrease information and the channel map created based on the VCT information and EIT information. The memory 7 is composed of an EEPROM, and the scheduled channel increase/decrease information and the channel map stored in the memory 7 are saved even when power supply is interrupted, and can be used immediately after power supply startup.

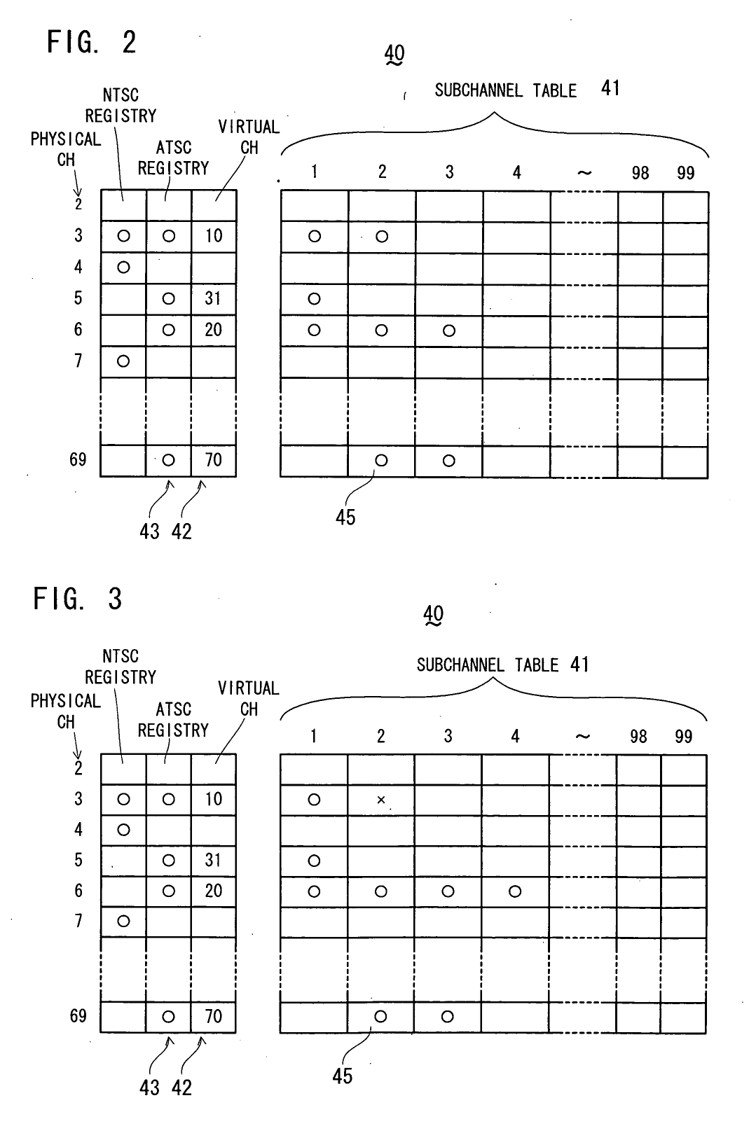

The channel map 40 stored in the memory 7 is composed of a subchannel table 41, a virtual CH (channel) table 42, an ATSC registry table 43, and the like, as shown in FIG. 2. The subchannel table 41 has a plurality of storage areas 45 that correspond to physical channels in the range of 2 to 69 and subchannels in the range of 1 to 99. A Source ID obtained from the EIT and VCT, which are electronic program information, is assigned to each storage area 45 within the subchannel table 41, and the subchannels currently being broadcast at each point in time are memorized based on the scheduled channel increase/decrease information. As exemplified in the diagram, it is shown that subchannel “10-1” (virtual channel “10” (physical channel “3”)-subchannel “1”), subchannel “10-2,” and the like are being broadcast at the current point in time.

Virtual channel numbers for the user to recognize and use are memorized in a correspondence relationship with each physical channel in the virtual CH table 42, and flags showing that the channels are currently being broadcast are set in the areas corresponding to the physical channels actually being broadcast in the ATSC registry table 43.

When an ATSC broadcast channel is selected with the remote control 2, the main processor 8 receives a signal from the remote control receiver unit 3, causes the tuner 4 to receive the television broadcast signal of the selected physical channel, and commands the decoder 5 to separate, extract, decode, and reproduce the audio and video signals of the selected subchannel. Also, the main processor 8 analyzes the EIT and VCT extracted by the decoder 5 and creates a channel map and scheduled channel increase/decrease information. The main processor 8 also assigns each Source ID and updates the electronic program information as the ATSC broadcast is being received, and updates the scheduled channel increase/decrease information stored in the memory 7. Furthermore, the main processor 8 also updates the channel map 40, which is based on the scheduled channel increase/decrease information.

When an analog broadcast channel is selected with the remote control 2, the main processor 8 receives a signal from the remote control receiver unit 3, causes the tuner 4 to receive the television broadcast signal of the selected channel, and causes decoder 5 to demodulate and reproduce the audio and video signals.

Next, the processing of the digital/analog broadcast receiver 1 during the operation of the channel up/down key 20 by the user is described with reference to FIG. 2. When a channel has been selected by the user with the aid of the channel up/down key 20, the broadcast receiver 1 selects the subchannel on the basis of the channel map 40. The channel map 40 is registered as shown in FIG. 2, and when the channel up key 20 is operated at a time at which the subchannel “10-1” has been selected, subchannel “10-2,” subchannel “20-1,” and so forth are selected in the order in which an “◯” mark is found in the subchannel table 41. When the channel down key 20 is operated, the programs are selected in the reverse order. In this case, the number of programs being broadcast varies together with time, so if the channel map 40 is left un-updated, a subchannel for which broadcasting ended already may be selected. For example, in the case that subchannel “10-2” is already not being broadcast, it is not known that the broadcast of subchannel “10-2” has ended until the physical channel “10” is selected, so when the channel down key 20 is operated at a time at which subchannel “20-1” had been selected, subchannel “10-2” will end up being selected. In view of the above, by automatically deleting the subchannels that are not being broadcast or adding the subchannels for which broadcasting has started on the basis of the scheduled channel increase/decrease information, the channel map 40 is updated, and the system operates so as to not select subchannels that are not being broadcast.

FIG. 3 is a diagram showing the state of the channel map 40 after a fixed interval of time has elapsed from the state of the channel map 40 shown in FIG. 2. The main processor 8 analyzes the EIT and VCT, creates scheduled channel increase/decrease information, obtains the broadcast end time for subchannels currently being broadcast and the broadcast start time for subchannels that are not currently being broadcast, and updates the channel map 40 on the basis of the scheduled channel increase/decrease information when these times arrive. In FIG. 3, when the broadcast of subchannel “10-2” has ended, the registration of subchannel “10-2,” indicated by “x” in the diagram, is deleted, and when the broadcast of subchannel “20-4” has started, the registration of subchannel “20-4” is added. By updating the channel map 40 in this manner, subchannel “10-1” can be selected without selecting subchannel “10-2”, which is not being broadcast, in the case that the channel down key 20 is operated when the subchannel “20-1” had been selected; and subchannel “20-4”, which is being broadcast, can be selected in the case that the channel up key 20 is operated when the subchannel “20-3” had been selected.

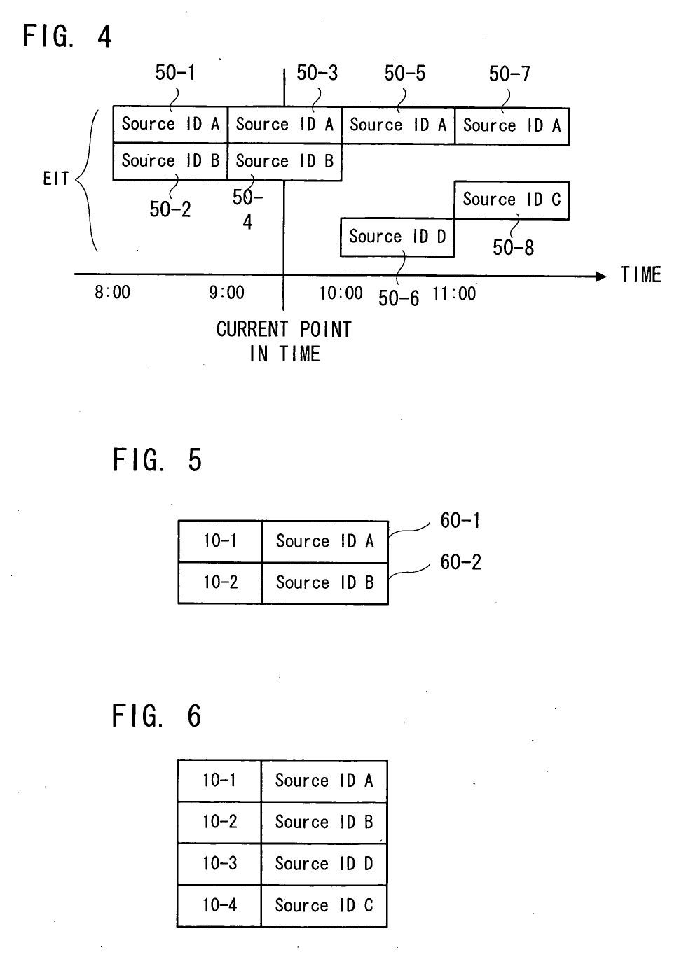

Next, a method for obtaining channel increase/decrease information from the EIT and VCT, and a method for updating the channel map 40 are described in detail with reference to FIGS. 4 and 5. At the point in time when an ATSC broadcast is being received in the physical channel “3,” it is assumed that EIT 50-1 to EIT 50-8, as shown in FIG. 4, and that VCT 60-1 to VCT 60-2, as shown in FIG. 5, are obtained. Program information (program name, broadcast time, and the like) for the respectively differing television programs is contained in these eight EIT 50-1 to EIT 50-8. It is also assumed that EIT 50-3 and EIT 50-4 contain program information for programs currently being broadcast. It is further assumed that information indicating that the Source ID is “A” is stored in EIT 50-1, EIT 50-3, EIT 50-5, and EIT 50-7; that the Source ID is “B” is stored in EIT 50-2, EIT 50-4; that the Source ID is “D” is stored in EIT 50-6; and that the Source ID is “C” is stored in EIT 50-8.

It is assumed that information indicating that channel “10-1” (virtual channel “10”-subchannel “1”) corresponds to Source ID “A” is stored in VCT 60-1, and that information indicating that channel “10-2” (virtual channel “10”-subchannel “2”) corresponds to Source ID “B” is stored in VCT 60-2, as shown in FIG. 5.

EIT 50-1 to EIT 50-8 do not directly hold the channel number information, as shown in FIG. 4. However, the correspondence between the channel number and Source ID is apparent from VCT 60-1 and 60-2, as shown in FIG. 5, so if the EIT holds a Source ID with the same value as the VCT, it can be concluded that the program indicated in the EIT is the program of the channel indicated in the VCT. The broadcast end times for the channels being broadcast are thereby calculated based on the EIT and VCT, and the channel numbers and broadcast end times can be stored as scheduled channel increase/decrease information. When the broadcast end time then arrives, the channels whose broadcast will end are deleted from the channel map 40. In the examples in FIGS. 4 and 5, the end time of subchannel “10-2” is 10:00, so the subchannel “10-2” is deleted from the channel map 40 at the time 10:00 arrives.

As for the Source ID “D” and Source ID “C”, the current VCT 60-1 and 60-2 do not have Source IDs, so when the channel number cannot be known from the past VCT, provisional channel numbers are assigned to Source ID “D” and Source ID “C,” and these numbers are stored as scheduled channel increase/decrease information. When assigning a provisional channel number to the Source ID, the smallest subchannel number is assigned from among the subchannel numbers that are currently not registered in the order from the earliest to the latest broadcast start times, in other words, in the order from Source ID “D” to Source ID “C”, as shown in FIGS. 4 and 6. Each subchannel is registered in the channel map 40 at the point in time in which the broadcast start time has arrived, based on the scheduled channel increase/decrease information. When the physical channel “3” (virtual channel “10”) is selected and the VCT is updated after provisional channel numbers have been assigned to Source ID “D” and Source ID “C” and stored as scheduled channel increase/decrease information, the channel numbers are reassigned to Source ID ‘D’ and Source ID ‘C’, and the channel numbers are reassigned in accordance with VCT in the case that the channel numbers corresponding to the Source IDs obtained from the VCT are different from the above-described provisionally assigned channel numbers.

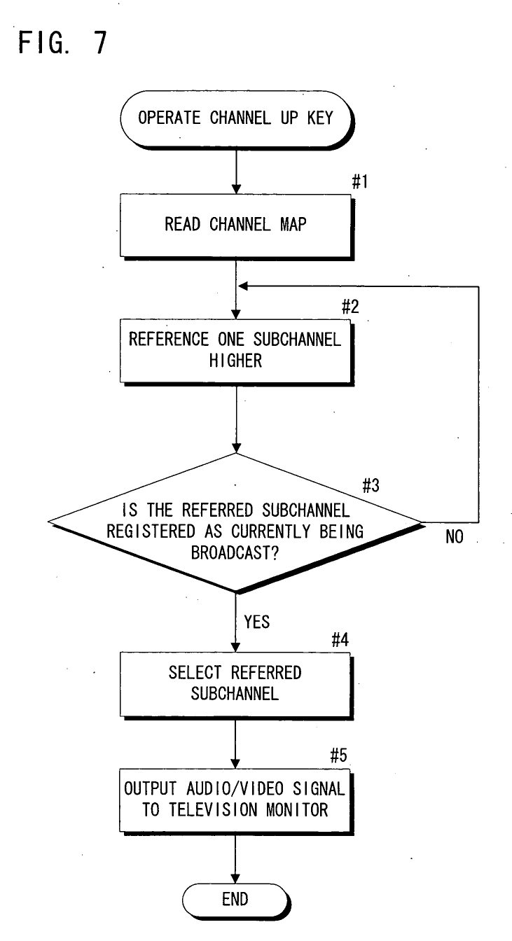

Next, the subchannel selection processing during operation of the channel up key 20 by the user is described with reference to FIG. 7. When the channel up key 20 is operated, the main processor 8 reads the channel map 40 from the memory 7 (#1), references the subchannel one step higher than the currently selected subchannel in ascending order on the basis of the channel map 40 (#2), and judges whether the referenced subchannel is registered in the channel map 40 as currently being broadcast (#3). If the referenced subchannel is not registered as currently being broadcast (NO, in #3), the subchannel one step higher is referenced and the processing in #2 and #3 is repeated until a subchannel that is registered as currently being broadcast is detected. When a subchannel that is registered as currently being broadcast is detected (YES, in #3), that subchannel is selected (#4), and the audio and video signals of the selected subchannel are output to the television monitor 30 (#5).

In accordance with the digital/analog broadcast receiver 1 according to the first embodiment described above, when the channel up/down key is operated by the user, subchannels that are not being broadcast are not selected, and the convenience of the user can be improved by selecting subchannels in the manner described above.

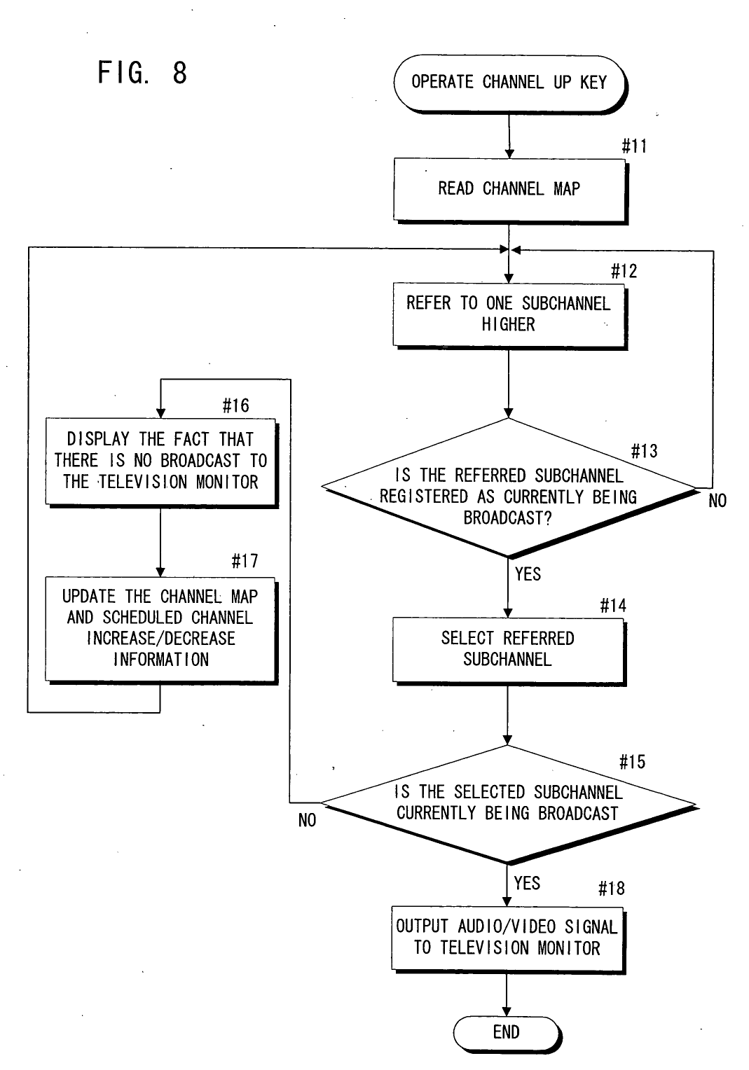

Next, the digital/analog broadcast receiver 1 according to a second embodiment is described with reference to FIG. 8. In the broadcast receiver 1 according to the second embodiment, channel selection during operation of the channel up key 20 by the user is different from the broadcast receiver 1 according to the first embodiment. The configuration and other aspects of the broadcast receiver 1 are the same as the first embodiment.

When the channel up key 20 is operated, the main processor 8 reads the channel map 40 from the memory 7 (#11), references the subchannel one step higher than the currently selected subchannel on the basis of the channel map 40 (#12), and judges whether the referenced subchannel is registered in the channel map 40 as currently being broadcast (#13). If the referenced subchannel is not registered as currently being broadcast (NO, in #13), the subchannel one step higher is referenced and the processing in #12 and #13 is repeated until a subchannel that is registered as currently being broadcast is detected. When a subchannel that is registered as currently being broadcast is detected (YES, in #13), that subchannel is selected (#14), and a judgement is made as to whether that subchannel is actually being broadcast (#15). Thus, the reason that a subchannel selected based on the channel map 40 is not always being broadcast is that in an ATSC broadcast, PSIP is distributed for each physical channel, so when channels are switched across a plurality of physical channels, the scheduled channel increase/decrease information of the selected physical channel may sometimes be not the newest information. When it is concluded that the subchannel is not actually being broadcast (NO, in #15), this result is output to the television monitor 30 (#16), the EIT and VCT are updated based on the newly received television broadcast signal, the scheduled channel increase/decrease information and the channel map 40 are updated (#17), and the processing in #12 to #15 is repeated. Conversely, when it is concluded that the selected subchannel is actually being broadcast (YES, in #15), the audio and video signals of the selected subchannel are output to the television monitor 30 (#18).

In accordance with the digital/analog broadcast receiver 1 according to the second embodiment, when the channel up/down key is operated by the user, subchannels that are not being broadcast are not selected, and the convenience of the user can be improved by selecting subchannels in the manner described above. Also, when the subchannel that is selected based on the channel map is not being broadcast, the fact that it is not being broadcast is displayed to the television monitor, and the channel map and scheduled channel increase/decrease information are automatically updated, so the convenience of the user can be improved.

This application is based on Japanese patent application 2003-163208 filed Jun. 9, 2003 in Japan, the contents of which are hereby incorporated by reference.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. A digital/analog broadcast receiver comprising:
receiving means for receiving an ATSC (Advanced Television Systems Committee) broadcast signal whereby video information about a plurality of television programs is distributed together with VCT (Virtual Channel Table) information showing the correspondence relationship between the channels that broadcast these television programs and the Source ID uniquely given to these channels, and EIT (Event Information Table) information showing the correspondence relationship between the Source ID and the program information for each television program;
a decoder for reproducing the video signal of the television program, outputting the video signal to a television monitor connected to the device, and extracting the EIT information and VCT information, from the ATSC broadcast signal received by the receiving means;
channel map creating means for creating a channel map wherein information as to whether each of the channels is being broadcast is stored, based on the extracted VCT information and EIT information;
operating means having a channel up/down key for allowing the user to select a desired channel;
channel selection control means for controlling the channel selecting processing on the basis of the channel up/down key operation by the user;
analysis means for analyzing the scheduled channel increase/decrease on the basis of the VCT information and EIT information while the ATSC broadcast signal is being received by the receiving means;
scheduled channel increase/decrease storage means for storing the scheduled channel increase/decrease information, which is the analysis result by the analysis means; and
channel map update means for updating the channel map at the scheduled channel increase/decrease time on the basis of the scheduled channel increase/decrease information stored in the scheduled channel increase/decrease storage means;
wherein said channel selection control means automatically selects the next channel in the up or down direction from among the channels currently registered in the channel map in accordance with the operation of the channel up/down key when it has been detected that the user has operated the channel up/down key.

2. The digital/analog broadcast receiver according to claim 1, wherein the channel selection control means judges whether or not the selected channel is actually being broadcast, and automatically selecting the next channel when it is concluded that the channel is not actually being broadcast.

3. The digital/analog broadcast receiver according to claim 1, wherein the channel selection control means judges whether or not the selected channel is actually being broadcast, and, when it is concluded that the channel is not actually being broadcast, outputs a signal indicating that fact to the television monitor, updates the channel map and the scheduled channel increase/decrease information stored in the scheduled channel increase/decrease storage means on the basis of the VCT and EIT information contained in the ATSC broadcast signal newly received from the receiving means, and automatically selects the next channel in the up or down direction from among the channels registered in the updated channel map.
